(19) United States
(12) Patent Application Publication
(10) Pub. No.: US 2015/0129660 A1
(43) Pub. Date: May 14, 2015

(54) METHOD AND APPARATUS FOR RETAINING AN ELECTRONIC TAG ON A DOWNHOLE TOOL

(71) Applicant: National Oilwell Varco L.P., Houston, TX (US)

(72) Inventors: Steven D. Laughlin, Katy, TX (US); Mark Arnspiger, Houston, TX (US); Haresh Ghansyam, Pearland, TX (US); Stefan M. Butuc, Woodlands, TX (US)

(73) Assignee: NATIONAL OILWELL VARCO, L.P., Houston, TX (US)

(21) Appl. No.: 14/076,464

(22) Filed: Nov. 11, 2013

(51) Int. Cl. G06K 19/077; E21B 12/00

(52) U.S. Cl. CPC G06K 19/07758; E21B 12/00
USPC 235/492; 29/460

(57) ABSTRACT

A trackable downhole tool includes a tool body having a tag mortise formed therein. The tag mortise has a female dovetail profile. An encapsulated electronic tag is retained in the mortise. The encapsulated electronic tag includes an electronic tag embedded in an encapsulation body. The electronic tag contains or is programmable to contain a unique asset identification code associated with the downhole tool. The encapsulation body has a male dovetail profile that cooperates with the female dovetail to form a dovetail joint that retains the encapsulated electronic tag in the tag mortise.

### FIELD

The field relates to methods and systems for tracking downhole tools.

### BACKGROUND

Systems have been developed for tracking downhole tools, e.g., components of a drill string or fishing tool. These systems typically use electronic identification tags, such as radio frequency identification (RFID) devices, and readers that can obtain tagged information from the tags. To track downhole tools, the tags have to be retained in some fashion on the downhole tools. The ability to retain these tags on the downhole tools and protect the tags while retained on the downhole tools and while drilling has been challenging and is one of the main reasons preventing widespread use of these tracking systems.

### SUMMARY

In one aspect, embodiments of the invention relate to a trackable downhole tool. In one illustrative embodiment, the trackable downhole tool includes a tool body having a tag mortise formed therein. The tag mortise has a female dovetail profile. An encapsulated electronic tag is retained in the tag mortise. The encapsulated electronic tag comprises an electronic tag embedded in an encapsulation body. The electronic tag contains or is programmable to contain a unique asset identification code associated with the downhole tool. The encapsulation body has a male dovetail profile that cooperates with the female dovetail profile to form a dovetail joint that retains the encapsulated electronic tag in the tag mortise.

In another aspect, embodiments of the invention relates to a method of manufacturing a trackable downhole tool. In one illustrative embodiment, the method includes forming a tag mortise having a female dovetail profile in a body of a downhole tool. The method further includes forming an encapsulated electronic tag by embedding an electronic tag in an encapsulation body made of a conformable material and having a dovetail profile, where the electronic tag contains or is programmable to contain a unique asset identification code associated with the downhole tool. The method includes retaining the encapsulated electronic tag in the tag mortise by conforming the encapsulation body to the tag mortise and forming a dovetail joint between the male dovetail profile and female dovetail profile.

It is to be understood that both the foregoing general description and the following detailed description are exemplary of various embodiments the invention and are intended to provide an overview or framework for understanding the nature and character of the disclosure as it is claimed. The accompanying drawings are included to provide a further understanding of the various embodiments of the invention and are incorporated in and constitute a part of this specification. The drawings illustrate various embodiments of the invention and together with the description serve to explain the principles and operation of the embodiments disclosed herein.

### BRIEF DESCRIPTION OF THE DRAWINGS

The following is a description of the figures in the accompanying drawings. The figures are not necessarily to scale, and certain features and certain views of the figures may be shown exaggerated in scale or in schematic form in the interest of clarity and conciseness.

FIG. 1 shows a trackable downhole tool.

FIG. 2A shows an encapsulated electronic tag.

FIG. 2B is a long side view of the encapsulated electronic tag of FIG. 2A.

FIG. 2C shows an encapsulated electronic tag with a convex top surface.

FIG. 3A is a cross-section of FIG. 2B along line 3A-3A showing an oblong encapsulated body cross-sectional profile.

FIG. 3B shows another oblong encapsulated body cross-sectional profile.

FIG. 3C shows a round encapsulated body cross-sectional profile.

FIG. 4A is a cross-sectional view of the encapsulated electronic tag of FIG. 2A along line 4A-4A.

FIG. 4B shows an encapsulated electronic tag having a bi-layered encapsulation body.

FIG. 4C shows an encapsulated electronic tag having a two-part encapsulation body.

FIG. 5A shows a cross-section of a tag mortise formed in a downhole tool.

FIG. 5B shows a cross-section of the downhole tool of FIG. 1 along line 5B-5B.

FIG. 5C shows an encapsulated electronic tag recessed in a tool body.

### DETAILED DESCRIPTION

In the following detailed description, numerous specific details may be set forth in order to provide a thorough understanding of embodiments of the invention. However, it will be clear to one skilled in the art that embodiments of the invention may be practiced without some or all of these specific details. In other instances, well-known features or processes may not be described in detail so as not to unnecessarily obscure the disclosure. In addition, like or identical reference numerals may be used to identify common or similar elements.

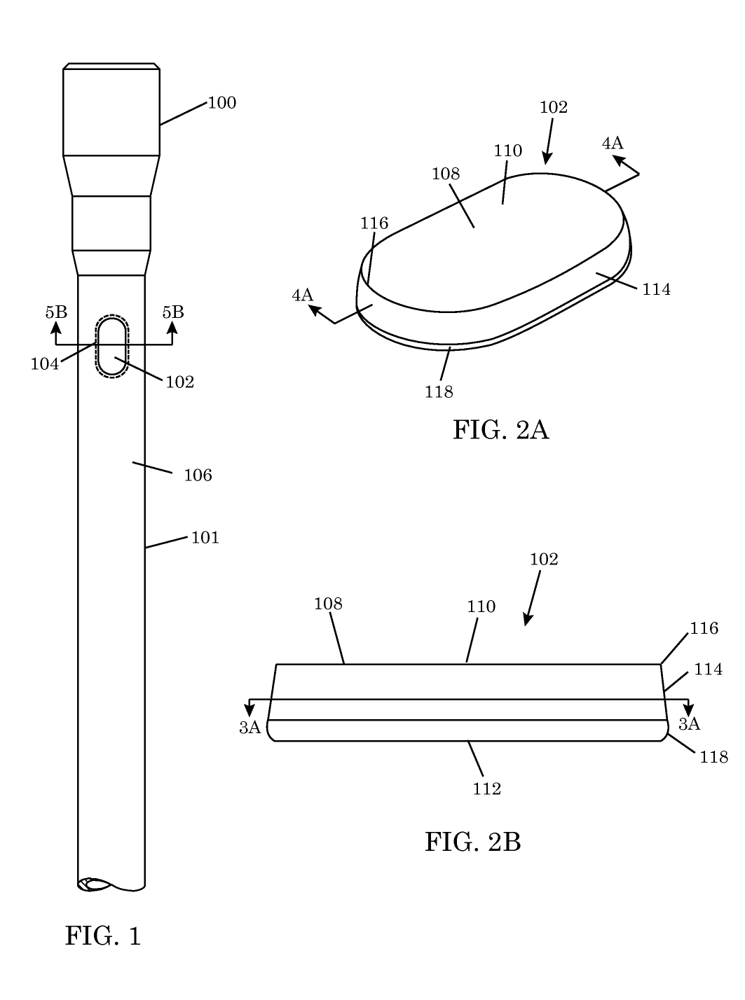

FIG. 1 shows a trackable downhole tool 100 that can be monitored via a suitable tracking system. In one or more illustrative embodiments, to enable tracking of the downhole tool 100, an encapsulated electronic tag 102 is retained in a tag mortise 104 formed in the body 101 of the downhole tool 100. In one embodiment, the tag mortise 104 is open to or accessible from the outer surface 106 of the tool body 101. However, the trackable downhole tool 100 is not limited to a single tag mortise and single encapsulated electronic tag. In alternate embodiments, the downhole tool may be provided with a plurality of tag mortises, and an encapsulated electronic tag may be retained in each tag mortise. Also, the downhole tool 100 is shown as a drill pipe for illustration purposes only. In general, the downhole tool 100 can be any tool or tool component used in conjunction with operations in a borehole and that needs to be tracked in some fashion. Examples of other downhole tools that could be tracked include, but are not limited to, bits, stabilizer subs, reaming subs, directional drilling tools, mud motors, jars, shock tools, intensifiers, float subs or other circulation valve subs, agitator tools, hammer tools, formation evaluation tools such as coring tools, and intervention tools such as fishing tools, valve shifting tools, and milling tools.

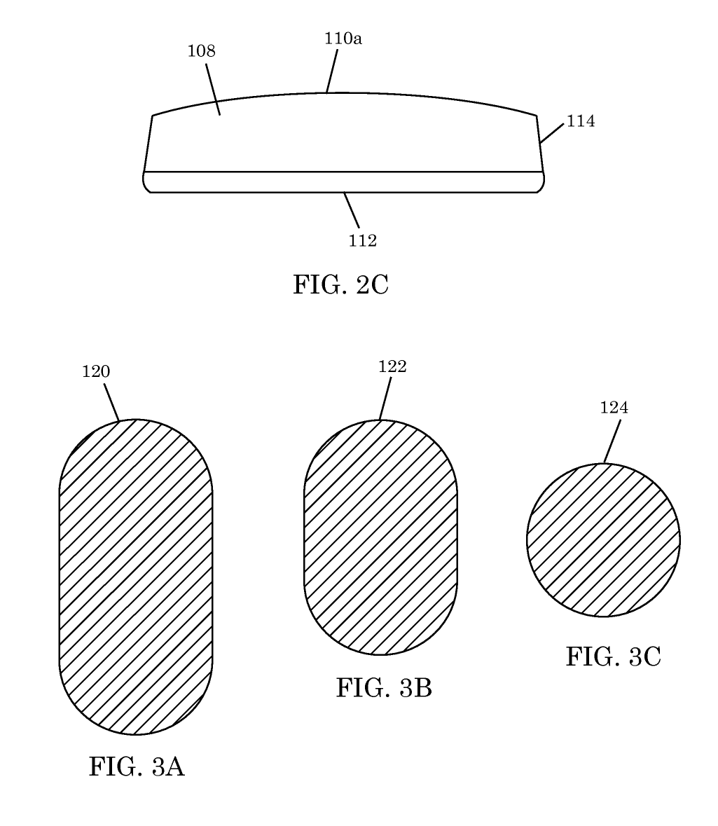

In one illustrative embodiment as shown in FIGS. 2A and 2B, the encapsulated electronic tag 102 includes an encapsulation body 108. In one embodiment, the encapsulation body 108 is a hermetically-sealed body. The encapsulation body 108 has a top surface 110, a bottom surface 112, and a side surface 114. The top surface 110 is in opposing relation to the bottom surface 112, and the side surface 114 extends between the top and bottom surfaces 110, 112. The side surface 114 is joined to the top surface 110 at a top corner 116 and to the bottom surface 112 at a bottom corner 118. The bottom corner 118 is rounded. In alternate embodiments, the top corner 116 may also be rounded. The side surface 114 is in the form of a tapered cylindrical surface, giving the encapsulation body 108 a tapered cylindrical shape that gradually narrows from the bottom corner 118 to the top corner 116. The tapered side surface 114 gives the encapsulation body 108 a male dovetail profile for forming a dovetail joint.

In the embodiment shown in FIGS. 2A and 2B, the top surface 110 of the encapsulation body 108 is flat. In alternate embodiments, the top surface 110 may not be flat. For example, the encapsulation body top surface may be slightly convex, as shown at 110a in FIG. 2C. In some embodiments, the encapsulation body top surface may be shaped in a profile that matches that of the outer surface (e.g., 106 in FIG. 1) of the tool body (e.g., 101 in FIG. 1). The bottom surface 112 is typically flat, although other shapes are possible. The bottom surface 112 may even incorporate surface texture to assist in retaining the encapsulated electronic tag 102 in the tag mortise (e.g., 104 in FIG. 1).

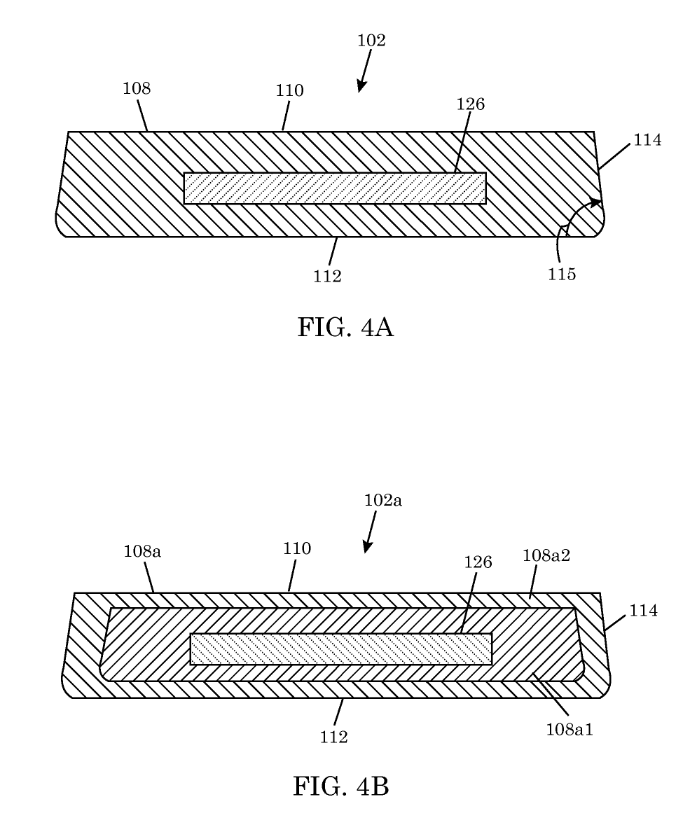

The encapsulation body 108 may have a variety of cross-sectional profiles, examples of which are shown in FIGS. 3A-3C. In FIG. 3A, the cross-sectional profile 120 is oblong. In FIG. 3B, the cross-sectional profile 122 is also oblong. The cross-sectional profile 122 is similar to the cross-sectional profile 120 in FIG. 3A, except that the sides of the cross-sectional profile 122 of FIG. 3B are shorter than the sides of the cross-sectional profile 120 in FIGS. 3A. In general, an oblong profile will have two orthogonal axes of different lengths. An oblong profile encompasses oval profile, rounded-rectangular profile, rectangular profile, elliptical profile, and the like. Typically, sharp corners that can result in localized stress concentration will be avoided in the cross-sectional profile of the encapsulation body. In FIG. 3C, the cross-sectional profile 124 is round.

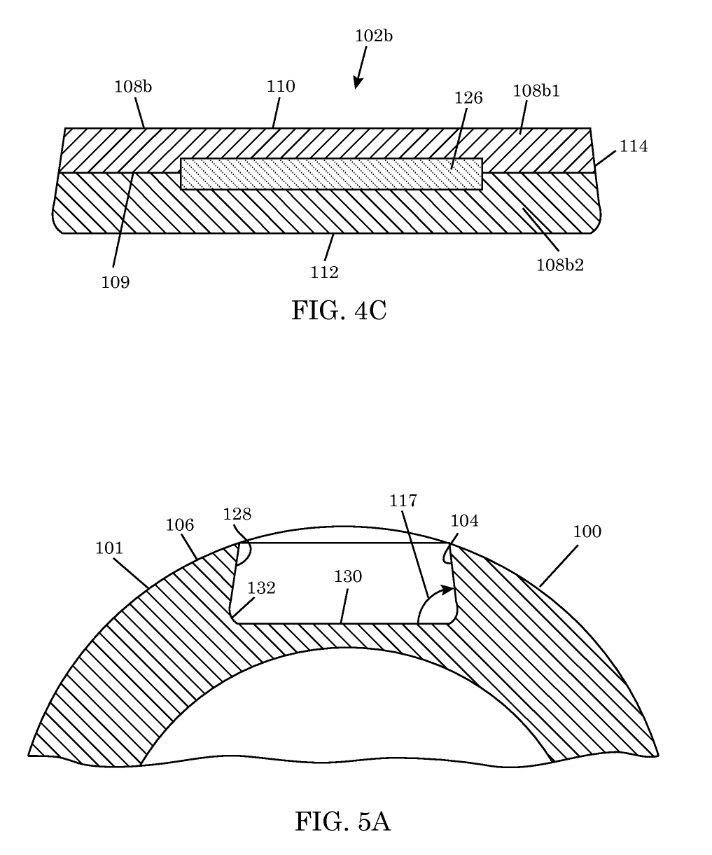

As shown in FIG. 4A, an electronic tag 126 is embedded inside the encapsulation body 108. The electronic tag 126 may be radio frequency identification (RFID) tag or other type of radio tag, e.g., long wavelength identification (LWID) tag. A commercial example of an LWID tag is a RuBee radio tag using IEEE 1902.1. The electronic tag 126 is provided as a complete device that is ready to use. In one embodiment, the electronic tag 126 contains a unique asset identification code (or is programmable to contain a unique asset identification code). When the encapsulated electronic tag 102 is retained on a downhole tool, as shown in FIG. 1 for example, it will then be possible to uniquely identify the downhole tool by the information contained in the electronic tag 126.

The encapsulation body 108 is made of a material that can withstand the conditions under which the downhole tool will be used. For example, if the downhole tool is to be inserted into a borehole, the encapsulation body 108 may be able to withstand the conditions in the borehole or may be coated with appropriate material that can withstand the conditions in the borehole. The encapsulation body 108 may also be made of a material that is permeable to radio signals, i.e., to allow for communication with the electronic tag 126 inside the encapsulation body.

In one embodiment, the encapsulation body 108 is made of a conformable material. This property will assist in retaining the encapsulation body 108 in the tag mortise formed in the tool body. In one embodiment, the conformable material is a polymer, typically an elastomer, e.g., a rubber. One suitable conformable material has the properties shown in Table 1 below. It may be possible to use nitrile butadiene rubber having a different acrylonitrile content than what is shown in Table 1 as the conformable material. Similarly, other polymers with similar mechanical properties to nitrile butadiene rubber may be used as the conformable material. In general, the appropriate conformable material for the environment of operation will need to be selected for the encapsulation body 108.

TABLE 1

| Polymer Type | nitrile butadiene rubber | |
|---|---|---|
| Acrylonitrile Content | 38% to 40% | |
| MDR Rheology at 150° C. Mooney High | 15 | lbf-in minimum |
| Torque | | |
| Cured Hardness (Shore A) | 77-83 | |
| Tensile Strength (ASTM D-412) | 1900 | psi minimum |
| Elongation at Break (ASTM D-412) | 250% | minimum |
| Tensile Modulus (ASTM D-412) at 100% | 600 | psi minimum |
| Elongation | | |
| Tear Resistance | 250 | psi minimum |

In one embodiment, the encapsulated electronic tag 102 is formed by molding a polymeric material over the electronic tag 126, where the over-molded polymer will serve as the encapsulation body. The over-molding process is controlled to avoid damaging, e.g., melting, the electronic tag 126. The over-molding process typically involves holding the electronic tag 126 in place within a framework of material to support the tag in the center of a mold. The tag may be oriented in the mold such that after the over-molding process, the antenna of the tag will face the top surface of the encapsulation body (e.g., 110 in FIG. 2A), where the top surface of the encapsulation body will be the outward facing surface of the encapsulated electronic tag 102 when the encapsulated electronic tag 102 is installed in the tag mortise. Then, the encapsulation body material is injected into the mold, creating a fully encapsulated electronic tag. The process involves curing of the injected material. The encapsulated body can be marked on the surface by altering the top half of the mold or by other means to show the top side of the encapsulated electronic tag.

In some embodiments, a conformal coating is applied to the electronic tag 126 prior to encapsulating the electronic tag. The conformal coating may assist in protecting the electronic tag 126 against moisture and temperature extremes, such as could be encountered in the downhole environment or even during the over-molding process. One example process involves conditioning the electronic tag at 120° C. to 135° C. for several hours, e.g., at least 24 hours, followed by spraying the chip side of the electronic tag with a thin layer of conformal coating material. One suitable example of a conformal coating material is silicone conformal coating, such as Miller-Stephenson MS-460C conformal coating. After spraying, the conformal coating is cured, e.g., for 12 hours at room temperature, followed by baking, e.g., for 24 hours at 90° C., followed by cooling. The conditioning temperature and time, curing time, and baking time are just examples based on the Miller-Stephenson MS-460C conformal coating. Other conformal coatings may require other settings. It is also possible to apply the conformal coating by other processes such as dip coating or brush coating. After applying the conformal coating, the electronic tag 126 can be encapsulated, e.g., by over-molding with a suitable polymer or using a different encapsulation method.

The encapsulation body 108 may have a single layer, as shown in FIG. 4A, or may have multiple layers. For example, it is possible to mold a first polymer over the electronic tag 126. This first polymer serves as the inner layer of the encapsulation body. Then, a second polymer can be molded over the inner layer. This second polymer serves as the outer layer of the encapsulation body. FIG. 4B shows an example of an encapsulated electronic tag 102a with a bi-layered encapsulation body 108a made of an inner layer 108a1 and an outer layer 108a2. The properties of the inner and outer layers can be different. For example, the inner layer 108a1 may be a softer polymer that will provide a cushion around the electronic tag 126, while the outer layer 108a2 may be a harder elastomer that will provide an outer protection for both the inner layer 108a1 and electronic tag 126.

The encapsulation body 108 may also be formed in two parts instead of being molded over the electronic tag 126 as a single part. The two parts can be arranged around the electronic tag 126 to encapsulate the electronic tag 126. FIG. 4C, for example, shows an encapsulated electronic tag 102b with a two-part encapsulation body 108b made of a top part 108b1 and a bottom part 108b2. The top part 108b1 and bottom 108b2 have inner recesses that will together form a chamber for receiving the electronic tag 126. The top part 108b1 and bottom part 108b2 can be joined together at the seam 109 using suitable means, such as bonding.

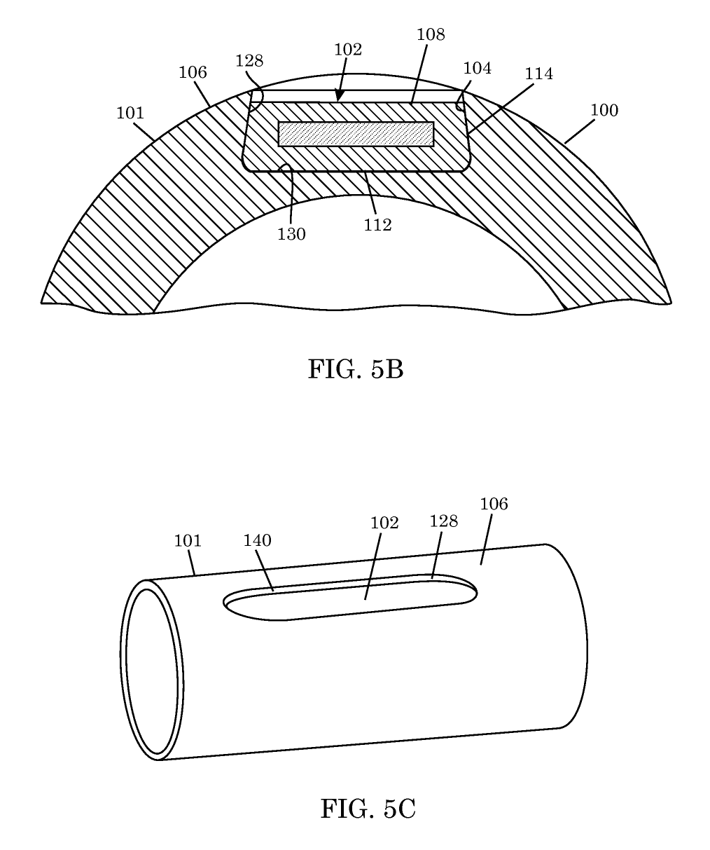

FIG. 5A shows the tag mortise 104 formed in the tool body 101 of the downhole tool 100. The tag mortise 104 is defined in part by a side surface 128 and in part by a bottom surface 130. The side surface 128 is joined to the bottom surface 130 at a bottom corner 132 and is connected at the top to the outer surface 106 of the tool body 101. The bottom corner 132 may be rounded as shown to avoid localized stress concentration at the bottom corner 132. The side surface 128 is in the form of a tapered cylindrical surface, giving the tag mortise 104 a tapered cylindrical shape that gradually narrows from the bottom corner 132 to the outer surface 106 (or outer diameter) of the tool body 101. The tapered side surface 128 gives the tag mortise 104 a female dovetail profile. The female dovetail profile is selected to interlock or cooperate with the male dovetail profile of the encapsulation body (e.g., 108 in FIG. 2A) to form a dovetail joint. The dovetail profiles of the encapsulation body 108 and tag mortise 104 may have various taper angles (115 in FIG. 4A and 117 in FIG. 5A) suitable for forming a dovetail joint.

Typically, the cross-sectional profile of the tag mortise 104 will match that of the encapsulated electronic tag (e.g., 102 in FIG. 2A). For example, if the encapsulation body has an oblong cross-sectional profile (e.g., 120 in FIG. 3A), the tag mortise 104 will also have an oblong cross-sectional profile.

FIG. 5B shows the encapsulated electronic tag 102 retained in the tag mortise 104. In one embodiment, in the unretained state, the encapsulation body 108 is oversized relative to the tag mortise 104. Where the encapsulation body 108 is made of a conformable material, the encapsulation body 108 can be slightly compressed to allow its insertion into the relatively smaller tag mortise 104.

To form the trackable downhole tool (e.g., 100 in FIG. 1), the encapsulated electronic tag 102 is inserted and pressed into the tag mortise 104 such that the encapsulation body side surface 114 frictionally engages the tag mortise side surface 128. In this state, the encapsulation body 102 will conform to the tag mortise 104. Also, the male dovetail profile of the encapsulation body 108 will be wedged against the female dovetail profile of the tag mortise 104, forming a dovetail joint that retains the encapsulated electronic tag 102 in the tag mortise 104. In one embodiment, firm but gentle pressure is applied to the encapsulated electronic tag 102 to press the encapsulated electronic tag 102 into the tag mortise 104 such that, as shown in FIG. 5C, a small lip of tool body material 140 exists between the top of the encapsulated electronic tag 102 and the outer diameter of the tag mortise 104, or such that the encapsulated electronic tag 102 is recessed relative to the outer surface 106 of the tool body 101. After installation, the electronic tag 126 inside the encapsulated electronic tag 102 can be tested to make sure that the electronic tag was not damaged during installation.

The encapsulated electronic tag 102 is designed to be embedded in a tool body that is typically made of metal. The encapsulated electronic tag 102 can be reliably embedded in the tool body via the tag mortise 104 without a need to further secure the encapsulated electronic tag 102 to the tool body using additional means such as bolting, bonding, and the like. In some embodiments, the encapsulated electronic tag 102 is designed for operation in a temperature range of −40° C. to 230° C. This may be achieved through the choice of encapsulation body material and electronic tag. In the case of the encapsulation body material, the nitrile butadiene rubber having the properties in Table 1 above or materials with similar properties can be used.

Samples of the encapsulated electronic tag 102 as described above have been embedded in downhole tools. In various studies, the embedded tag samples remained retained on the tools after 100, in some cases after 197, cumulative run hours of the tool. It was also demonstrated that the embedded encapsulated electronic tag samples could withstand pressures up to 20,000 psi.

While the present disclosure has described a limited number of embodiments, those skilled in the art, having benefit of this disclosure, will appreciate that other embodiments can be devised which do not depart from the scope of the disclosure. Accordingly, the scope of protection is not limited by the description set out above, but is only limited by the claims which follow, that scope including all equivalents of the subject matter of the claims.

1. A trackable downhole tool, comprising:
a tool body having a tag mortise formed therein, the tag mortise having a female dovetail profile; and
an encapsulated electronic tag retained in the tag mortise, the encapsulated electronic tag comprising an electronic tag embedded in an encapsulation body, the electronic tag containing or programmable to contain a unique asset identification code associated with the downhole tool, the encapsulation body having a male dovetail profile that cooperates with the female dovetail profile to form a dovetail joint that retains the encapsulated electronic tag in the tag mortise.

2. The trackable downhole tool of claim 1, wherein the encapsulation body is made of a conformable material.

3. The trackable downhole tool of claim 1, wherein the encapsulation body is made of a polymer.

4. The trackable downhole tool of claim 1, wherein the encapsulation body is made of nitrile butadiene rubber.

5. The trackable downhole tool of claim 1, wherein the encapsulation body has an oblong cross-sectional profile.

6. The trackable downhole tool of claim 1, wherein the encapsulation body has a round cross-sectional shape.

7. The trackable downhole tool of claim 1, wherein the encapsulation body is an over-molded polymer.

8. The trackable downhole tool of claim 1, wherein a cross-sectional profile of the encapsulation body matches a cross-sectional profile of the tag mortise.

9. The trackable downhole tool of claim 8, wherein the encapsulation body is oversized relative to the tag mortise prior to insertion of the encapsulated electronic tag into the tag mortise.

10. The trackable downhole tool of claim 1, wherein the encapsulated electronic tag is recessed in the tool body.

11. The trackable downhole tool of claim 1, wherein the electronic tag is selected from a group consisting of a radio frequency identification tag and a long wavelength identification tag.

12. The trackable downhole tool of claim 1, wherein the conformable material and the electronic tag are selected such that the encapsulated electronic tag is operable in a temperature range from −40° C. to 230° C.

13. The trackable downhole tool of claim 1, wherein the encapsulation body comprises an inner layer of a first conformable material and an outer layer of a second conformable material, wherein the first conformable material is different from the second conformable material.

14. A method of manufacturing a trackable downhole tool, comprising:
forming a tag mortise having a female dovetail profile in a body of a downhole tool;
forming an encapsulated electronic tag by embedding an electronic tag in an encapsulation body made of a conformable material and having a male dovetail profile, wherein the electronic tag contains or is programmable to contain a unique asset identification code associated with the downhole tool; and
retaining the encapsulated electronic tag in the tag mortise by conforming the encapsulation body to the tag mortise and forming a dovetail joint between the male dovetail profile and female dovetail profile.

15. The method of claim 14, wherein the conformable material is a polymer and forming the encapsulated electronic tag comprises molding the polymer over the electronic tag, wherein the polymer molded over the electronic tag is the encapsulation body.

16. The method of claim 15, further comprising applying a conformal coating to the electronic tag prior to molding the polymer over the electronic tag.

17. The method of claim 15, wherein the polymer is nitrile butadiene rubber.

18. The method of claim 14, further comprising selecting the electronic tag from a group consisting of a radio frequency identification tag and a long wavelength identification tag.

19. The method of claim 14, wherein retaining the encapsulated electronic tag comprises pressing the encapsulated electronic tag into the tag mortise such that the encapsulated electronic tag is recessed in the body of the downhole tool.

20. The method of claim 14, wherein forming the encapsulated electronic tag comprises forming the encapsulation body in a size that is larger than the tag mortise.
